(19) United States
(12) Patent Application Publication
(10) Pub. No.: US 2009/0229201 A1
(43) Pub. Date: Sep. 17, 2009

(54) Hurricane and break-in resistant apparatus and method

(76) Inventors: Brad Hanssen, Pace, FL (US); Neil Richards, Pensacola, FL (US); Riley Burke, Pensacola, FL (US)

Correspondence Address: J. Nevin Shaffer Jr. P.A.,, Suite 43, 913 Gulf Breeze Parkway, Gulf Breeze, FL, 32561, US

(21) Appl. No.: 12/075,693

(22) Filed: Mar. 13, 2008

(51) Int. Cl. E06B 5/10; E06B 5/12; E06B 5/11

(52) U.S. Cl. 52/202; 52/204.51; 52/745.15

(57) ABSTRACT

A hurricane and break-in resistant window apparatus and method includes a first window assembly with a movable partition with an interior surface and an exterior surface, in which the partition is movable from a closed position to an open position. A second window assembly, which is approximately identical in dimension to the first window assembly is provided with a movable hurricane and break-in resistant partition, the hurricane and break-in resistant partition being conformed to move in the same manner as the first window assembly partition from a closed position to an open position. A connection device is provided for connecting the second window assembly over the first window assembly such that the exterior surface of the first window assembly is covered by the second window assembly.

### FIELD OF THE INVENTION

This invention relates to a hurricane and break-in resistant window apparatus and method for use with structures with windows. In particular, in accordance with one embodiment, the invention relates, in a structure with a first window assembly with a movable partition with an interior surface and an exterior surface, in which the partition is movable from a closed position to an open position, to a hurricane and break-in resistant window apparatus including a second window assembly, which is approximately identical in dimension to the first window assembly is provided with a movable hurricane and break-in resistant partition, the hurricane and break-in resistant partition being conformed to move in the same manner as the partition from a closed position to an open position. A connection device is provided for connecting the second window assembly over the first window assembly such that the exterior surface of the first window assembly is covered by the second window assembly.

### BACKGROUND OF THE INVENTION

Applicant is the inventor of prior U.S. Pat. No. 6,564,517 for a Hurricane Resistant Storm Window Assembly incorporated hereby by reference. As such, it is clear that the Applicant is especially skilled and knowledgeable in the field of apparatus and methods for protecting windows from wind blown debris. In this regard, Applicant has determined that there is still a need in the art for an easy to use, effective hurricane and break-in resistant window covering that is not expensive to make and time consuming to install. The prior art window coverings known to Applicant include fabric, screen and metal covers that are supported in a custom made frame. The frame is then added in place over the window to be protected and secured in place by screws, bolts and the like. That is, the prior art devices are meant to remain in place once installed much like burglar bars. Like burglar bars, these devices do not attempt to match the underlying window and thus stand out when installed as obtrusive, eye catching, obvious add ons.

Some prior art devices include a hinge or a latch that allows a person some chance of moving the cover out of the way so that egress from the structure is enabled. When a fire occurs, for example, a window may be the only way out. Prior art devices have provided for egress but only in the most rudimentary and, more importantly, difficult manner. That is, the prior art coverings, whose primary purpose is to shield a window from wind blown debris, are designed to be held securely in place during a storm event, such as a hurricane. Thus, they are designed not to move. Moving them out of the way is a very secondary feature and the state of the art, again, consists of difficult to operate latches if even that. Once the latch is operated, the prior art devices of which Applicant is aware, are hinged along one side, top or bottom, and the entire device swings away from the window. These are difficult at best to operate and even may in fact not be possible to operate in a high wind event in that the wind could keep the cover closed against the window.

In any event, the prior art coverings are expensive to construct and hard to operate. Applicant has determined that prior art coverings are approximately twice as expensive to construct as compared to Applicant's invention disclosed herein. The prior art covers that are made of metal are essentially metal doors or windows that take about three hours to install for a typical four foot by five foot opening.

Thus, there is a need in the art for an apparatus and method for providing window protection from flying debris and break-in security that is inexpensive to construct and may be quickly installed. Further there is a need for an apparatus that enables a user to simply, safely and easily operate it to allow egress from the covered window when necessary. It, therefore, is an object of this invention to provide a hurricane and break-in resistant window apparatus and method that provides extreme wind blown debris and break-in protection for windows that is easy to operate, even in the midst of storm events, and that is inexpensive, unobtrusive and effective.

### SUMMARY OF THE INVENTION

Accordingly, a hurricane and break-in resistant apparatus, according to one embodiment of the invention, in a structure with a first window assembly with a movable partition with an interior surface and an exterior surface, the partition movable from a closed position to an open position, includes a second window assembly, which is approximately identical to the first window assembly, is provided with a movable hurricane and break-in resistant partition, the hurricane and break-in resistant partition is conformed to move in the same manner as the first window assembly partition from a closed position to an open position. A connection device is provided for connecting the second window assembly over the first window assembly such that the exterior surface of the first window assembly is covered by the second window assembly.

In particular, as set forth above, important features of this invention include the second window assembly constructed essentially identically to the first window assembly. This feature enables a user to maintain the look of the window in that no awkward looking or extra frame parts stand out when installed. Prior art window covers always look like they are added on extras because they are and because of the fact they do not mimic the original window except in a gross way. Additionally, this feature keeps the cost of the apparatus down. Once a widow has been selected for protection, the user simply uses the same or substantially similar frame assembly to support the hurricane and break-in resistant partition, as will be discussed more fully hereafter. Thus, a unique one at a time frame is not required to be laboriously and expensively created. A further advantage of this aspect of the invention is that a user does not have to learn two separate techniques for operating the partitions. The first window assembly partition and the hurricane and break-in resistant partition operate identically. Thus, when the need arises, a user that opens the first window assembly partition simply operates the hurricane and break-in resistant partition in the identical manner to open it as well. In time of an emergency, this is a tremendous help to the user and a life saving time saver.

According to another aspect of the invention, a handle is connected with the movable partition and the movable hurricane and break-in resistant partition. In other aspects, the movable partition is a laminated glass partition and the hurricane and break-in resistant partition is metal. Obviously, the underlying first window assembly partition may be made of any material, glass, plastic, metal or the like or of any material now known or hereafter developed that a user wishes to protect.

In further aspects, the hurricane and break-in resistant partition is perforated steel. In another aspect, the hurricane and break-in resistant partition is a stainless steel screen in which the strands of the screen are approximately 0.03 inches in diameter. In one aspect, there are approximately one hundred and forty four strands per square inch of the screen.

According to further aspects, the first window assembly is a single hung window assembly and the movable partition moves vertically up and down. In another aspect, the first window assembly is a sliding assembly and the movable partition moves horizontally left and right.

According to another embodiment of the invention, a hurricane and break-in resistant window apparatus, in a structure with a first window assembly with a first partition with an interior surface and an exterior surface and a second partition with an interior surface and an exterior surface, at least one of the first window assembly partitions movable from a closed position to an open position, includes a second window assembly, which is approximately identical in dimension to the first window assembly with a first hurricane and break-in resistant partition and a second hurricane and break-in resistant partition, and at least one of the hurricane and break-in resistant partitions is conformed to move in the same manner as the first window assembly partitions from a closed position to an open position. Further, the second window assembly includes a first frame surrounding the first hurricane and break-in resistant partition and a second frame surrounding the second hurricane and break-in resistant partitions such that the frames may be movable within the second window assembly. A connection device is provided for connecting the second window assembly over the first window assembly such that the first window assembly is exactly covered by the second window assembly.

As used herein, the term “exactly covered” is used in a real world sense that the second window assembly is approximately identical in dimension to the first window assembly. Thus, the term “exactly covered” means that the second window assembly is aligned with the first window assembly and then secured in place. There will be slight deviations in dimensions and installation that result in some small and insignificant portions of the first assembly not being covered by the second window assembly. This is acceptable and included within the term “exactly covered” as used herein. The essential point is that the two window assemblies are approximately the same, and may in fact event be interchangeable, and one is placed over and aligned with the other. This results in an essentially exact covering as is expected when two things are approximately identical.

In another aspect, the hurricane and break-in resistant partition is metal. In a further aspect, the hurricane and break-in resistant partition is perforated stainless steel. In a further aspect, the hurricane and break-in resistant partition is a stainless steel screen in which strands of the screen are approximately 0.03 inches in diameter and there are approximately one hundred and forty four strands per square inch of the screen. In another aspect, the first window assembly is a single hung window assembly and the movable partition moves vertically up and down. In another aspect, the first window assembly is a sliding assembly and the movable partition moves horizontally left and right.

According to another embodiment of the invention in a structure with a first window assembly with a first movable partition with an interior surface and an exterior surface, the first movable partition movable from a closed position to an open position, a method for providing a hurricane and break-in resistant window includes providing: a second window assembly, which is approximately identical in dimension to the first window assembly with a first movable hurricane and break-in resistant partition, the first movable hurricane and break-in resistant partition conformed to move in the same manner as the first movable partition from a closed position to an open position and connecting the second window assembly over the first window assembly such that the first window assembly is exactly covered by the second window assembly.

According to another aspect, the hurricane and break-in resistant partition is perforated metal. In another aspect, the hurricane and break-in resistant partition is a stainless steel screen in which strands of the screen are approximately 0.03 inches in diameter. In another aspect, the first window assembly is a single hung window assembly and the movable partition moves vertically up and down. In another aspect, the first window assembly is a sliding assembly and the movable partition moves horizontally left and right.

### DESCRIPTION OF THE DRAWINGS

Other objects, features and advantages of the present invention will become more fully apparent from the following detailed description of the preferred embodiment, the appended claims and the accompanying drawings in which:

FIG. 1 is a front view of the hurricane and break-in resistant window assembly of the present invention according to one embodiment in the form of a horizontally movable window;

FIG. 2 is a side view of the first widow assembly of the invention of FIG. 1; and

FIG. 3 is a top view of the first window assembly and the second window assembly of the invention of FIGS. 1 and 2.

### DETAILED DESCRIPTION OF THE INVENTION

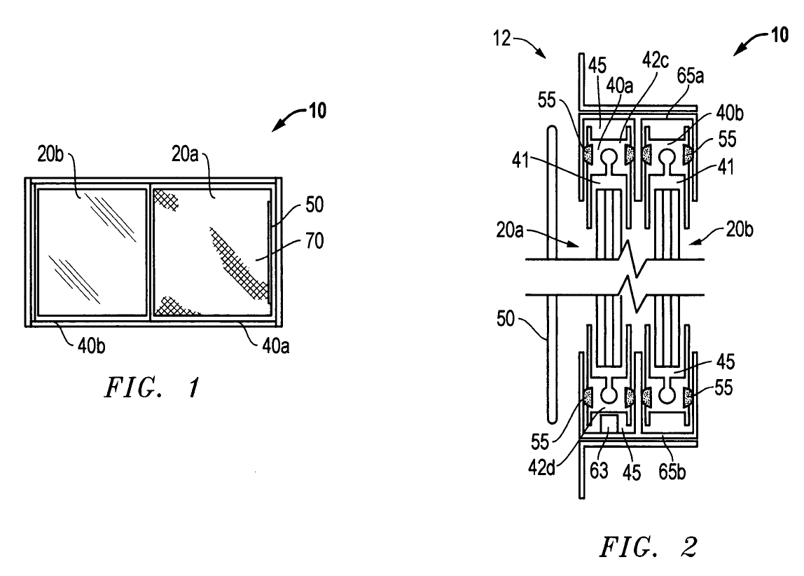

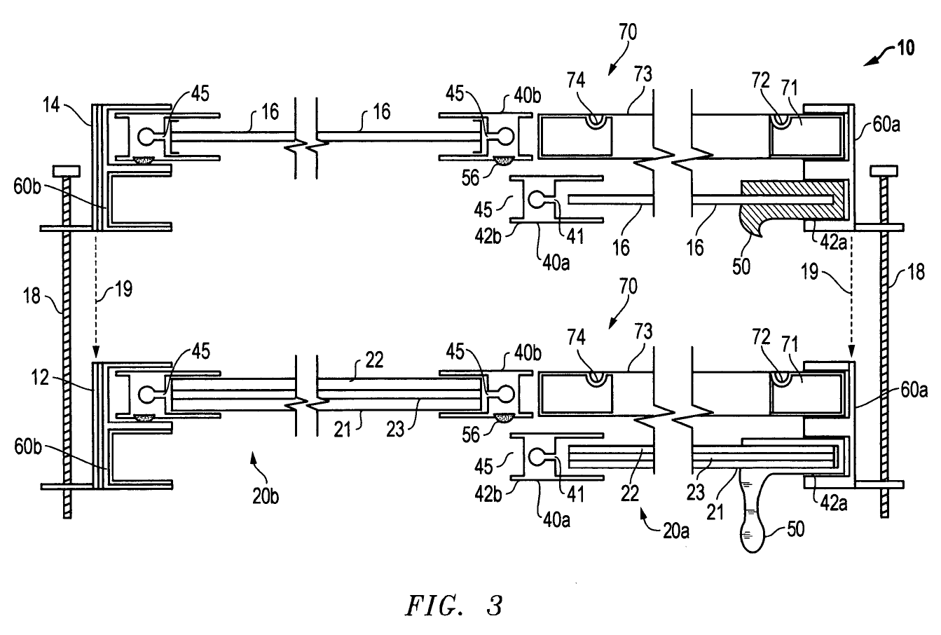

The preferred embodiment of the present invention is illustrated by way of example in FIGS. 1-3. With specific reference to FIGS. 1-3, according to one embodiment, hurricane and break-in resistant window apparatus 10 is illustrated in a right to left-hand glider type and is used in structures including an underlying first widow assembly 12. It is important to the understanding of the form and function of second window assembly 14 and hurricane and break-in resistant partition 16 (as will be discussed more fully hereafter with reference to FIG. 3) to clearly describe the form and function of first window assembly 12. First window assembly 12 may be any type or form of window assembly now known or hereafter developed but may be generally understood to be comprised of a first window assembly 12 which may include a first partition 20a, second partition 20b, first and second frame members 40a and 40b and handle 50. Certainly, it may be that only a single partition is required and or only one or the other of the partitions 20a or 20b moves. Again, it will be the normal case for the underlying first window assembly 12 to be made up of partition(s) 20a and/or 20b that are made of glass. Thus, Applicant hereafter describes them as such herein but not by way of limitation as they may be made of any suitable material.

First and second glass partitions 20a and 20b each consist of a common window pane of glass. According to one embodiment, the first and second glass partitions 20a and 20b consist of a first glass substrate 21 and a second glass substrate 22 and vinyl layer 23. As more particularly set forth in Applicant's U.S. Pat. No. 6,564,517, this combination provides a hurricane-resistant storm window pane and greatly diminishes the risk of storm intrusion through breakage of the window. Nonetheless, greater hurricane protection and security is provided by way of the present invention as set forth more fully herein.

Continuing, first and second glass partitions 20a and 20b, if both are present, are preferably surrounded around the outer perimeter edge by a frame, first frame 40a and second frame 40b. The first glass partition 20a in combination with first frame 40a defines a first window portion. The second glass partition 20b in combination with second frame 40b defines a second window portion.

First frame 40a is a border frame defining a border channel 41 which receives therein the outer perimeter edge of first glass partition 20a. The outer perimeter edge of first glass partition 20a is secured in the border channel 41 by any conventional securing and sealing means as is well known. A right side portion 42a of the border frame preferably includes handle 50. As illustrated, in one embodiment, handle 50 extends along a significant portion of the length of right side portion 42a. Handle 50 is used, as is known, to move first glass partition 20a from right to left in FIG. 1 so as to open first window assembly 12. Once open, a person, not shown, can egress a structure when and if needed, such as in a storm or fire, for example only and not by way of limitation.

Right and left side portions 42a and 42b of the border frame are slidably coupled between right and left window jamb channel members 60a and 60b, respectively. In a preferred embodiment, right and left window jamb channel members 60a and 60b are each generally “M” shaped defining a forward channel and a rear channel. The right side portion 42a of the border frame is dimensioned to fit in the forward channel of the window jamb channel 60a such that first window assembly 12 is in a closed position when right side portion 42a is fully received in the forward channel of right window jamb channel 60a. On the other hand, left side portion 42a is adapted to be slidably received in forward channel of left window jamb channel 60b as the first glass partition 20a is slid left. When right side portion 42a is slid out of the forward channel of right window jamb channel 60a, the first window assembly 12 is in an open position. Obviously, the invention may be assembled so as to operate as a left to right opening device or as a single hung, vertically opening device with it opening from the top or the bottom.

Still referring to FIGS. 1-3, the left side, top and bottom portions 42b, 42c and 42d of the border frame of the first glass partition 20a include shallow channel 45 opposite the border channel 41 wherein shallow channel 45 receives therein guide member 63 fixedly secured in the center of the forward channel of bottom window jamb channel 65b. The front and back exterior surfaces of the top, bottom and left side portions 42b, 42c and 42d include, preferably, weatherstrips 55.

Right side portion 42a differs from left side portion 42b in that shallow channel 45 is omitted. Furthermore, the border channel 41 is deeper to provide the necessary integration of the handle 50 therewith.

Top and bottom window jamb channels 65a and 65b are generally “M” shaped and serve to maintain the first glass partition 20a and the second glass partition 20b aligned. Top portion 42c and bottom portion 42d of the border frame of the first glass partition 20a are slidably received in the forward channel of top and bottom window jamb channels 65a and 65b.

Second frame 40b is a border frame defining a border channel 45 which receives therein the outer perimeter edge of second glass partition 20b. The outer perimeter edge of second glass partition 20b is secured in border channel 45 by any conventional sealing and securing means. Left side portion 46b of the border frame is fixedly secured and sealed in the rear channel of left window jamb channel 60b. Right side portion 46a of the border frame includes weatherstrip 56 for sealing first frame 40a and second frame 40b therealong. Moreover, second frame 40b is fixedly secured in top and bottom window jamb channels 65a and 65b.

In one embodiment, first frame 40a, second frame 40b, right and left window jamb channel 60a and 60b and top and bottom window jamb channels 65a and 65b are made of aluminum.

Hurricane and break-in resistant window apparatus 10 further may include, particularly with first window assembly 12, a bug screen assembly 70 which is adapted to be secured along the rear or exterior side of first glass partition 20a. Thereby, when said first glass partition 20a is slid to the left, for example only and not by way of limitation, screen assembly 70 provides a bug barrier, as is known. Screen assembly 70 includes a screen frame 71 having a border notch 72 and screen mesh 73. Screen mesh 73 is secured to screen frame 71 via resilient cord 74 friction fit in border notch 72, again as is known. Importantly, screen assembly 70 is easily pushed out of the way in case it is necessary to exit from first window assembly 12. Once the glass partition is slid out of the way, a user simply pushes outward on screen mesh 73 to free it from capture by cord 74. Also, preferably screen mesh 73 is merely a bug screen, made of a small weave fabric that is easily cut if needed.

Referring now particularly to FIG. 3, the complete hurricane and break-in resistant window assembly 10 is shown wherein first window assembly 12, as just described in detail, is shown in association with second window assembly 14. Preferably, second window assembly 14 is identical, or approximately so, to first window assembly 12. In the figures, identical numbers identify identical structures in both first window assembly 12 and second window assembly 14. Importantly, however, second window assembly 14 includes movable hurricane and break-in resistant partition 16 in place of both first glass partition 20a and/or second glass partition 20b, if present. Otherwise, second window assembly 14 is identical or nearly so to first window assembly 12. It may even be the case that the two window assemblies are interchangeable and identical in fact. This feature allows the invention to be kept cost effective. Further, this feature prevents the hurricane and break-in resistant window assembly apparatus 10 from standing out as an obvious addition to a structure with first window assembly 12. Because they are identical or nearly so, the appearance is of an ordinary window. This appearance feature is further enhanced by including screen assembly 70 to second window assembly 14. Clearly it is redundant, but, nonetheless, if added its presence adds to the “normal” appearance feature of the present invention.

More importantly, second window assembly 14 includes handle 50 in the same location on second window assembly 14 as handle 50 on first window assembly 12. This feature greatly enhances the user's ability to safely and quickly open first window assembly 12 and then open second window assembly 14 in the same manner. No separate opening mechanism or maneuver must be overcome as in prior art devices. Still further, second window assembly 14 opens in the same manner as first window assembly 12 in that hurricane and break-in resistant partition 16 slides horizontally, or vertically if in a single hung assembly, and does not swing out into the weather away from the structure as required by prior art devices. As mentioned, prior art metal window covers, like burglar bars, that swing away from the covered window, may not in fact be able to be moved against a strong wind, as in a hurricane. Thus, Applicant's hurricane and break-in resistant window assembly 10 provides an added safety factor as well.

It should be noted in FIG. 3 that handle 50 of second window assembly 14 may be slightly smaller than corresponding handle 50 on first window assembly 12. This reduction of size enables second window assembly 14 to be connected by connections 18 directly on top of the exterior of first window assembly 12 as indicated by dotted direction arrows 19. Connections 18 may be screws, bolts, nails or any other connection now known or hereafter developed for securing second window assembly 14 exactly on top of the exterior surface of first window assembly 12. The structural requirement is simply that the second window assembly 14 cover the first window assembly 12 so that hurricane and break-in resistant partition 16 covers and protects first and second glass partition 20a and 20b from debris and break-in.

Hurricane and break-in resistant partition 16 may be metal or impact resistant fabric or any impact resistant material now known or hereafter developed. According to one embodiment of the invention, hurricane and break-in resistant partition 16 is a perforated stainless steel. In another, it is a stainless steel screen in which the strands of the screen are approximately 0.03 inches in diameter. In another aspect of this invention, there are approximately one hundred and forty four strands per square inch of the stainless steel screen. Applicant has determined that such screens are light weight, easy to assemble and surprisingly resistant to wind blown debris and break-ins.

As used herein the term “beak-in” means forced entry past the second window assembly 14 to first window assembly 12. Just as second window assembly 14 may be opened in the same manner as first window assembly 12 so is it closed in the same manner. Once second window assembly 14 is closed it is in a “locked” position and can not easily be opened from the outside. Thus, once closed the second window assembly 14 provides not only hurricane protection but break-in protection as well.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

What is claimed is:

1. In a structure with a first window assembly with a movable partition with an interior surface and an exterior surface, the partition movable from a closed position to an open position, a hurricane and break-in resistant window apparatus comprising:
a. a second window assembly, which is approximately identical in dimension to said first window assembly with a movable hurricane and break-in resistant partition, the hurricane and break-in resistant partition conformed to move in the same manner as the first window assembly partition from a closed position to an open position; and
b. a connection means for connecting said second window assembly over said first window assembly such that said exterior surface of said first window assembly is covered by said second window assembly.

2. The apparatus of claim 1 further including a handle connected with said first window assembly movable partition and a handle connected with said movable hurricane and break-in resistant partition.

3. The apparatus of claim 1 wherein said first window assembly movable partition is a laminated glass partition.

4. The apparatus of claim 1 wherein said hurricane and break-in resistant partition is metal.

5. The apparatus of claim 1 wherein said hurricane and break-in resistant partition is perforated stainless steel.

6. The apparatus of claim 1 wherein said hurricane and break-in resistant partition is stainless steel screen wherein strands of said screen are approximately 0.03 inches in diameter.

7. The apparatus of claim 6 wherein there are approximately one hundred and forty four strands per square inch of said screen.

8. The apparatus of claim 1 wherein said first window assembly is a single hung window assembly and said first window assembly movable partition moves vertically up and down.

9. The apparatus of claim 1 wherein said first window assembly is a sliding assembly and said first window assembly movable partition moves horizontally left and right.

10. In a structure with a first window assembly with a first partition and a second partition with an interior surface and an exterior surface, and at least one of the first window assembly partitions is movable from a closed position to an open position, a hurricane and break-in resistant window apparatus comprising:
a. a second window assembly, which is approximately identical in dimension to said first window assembly with a first hurricane and break-in resistant partition and a second hurricane and break-in resistant partition, at least one of the hurricane and break-in resistant partitions conformed to move in the same manner as the first window assembly partitions from a closed position to an open position;
b. the second window assembly including a first frame surrounding said first hurricane and break-in resistant partition and a second frame surrounding said second hurricane and break-in resistant partition such that said frames are movable within said second window assembly; and
c. a connection means for connecting said second window assembly over said first window assembly such that said first window assembly is exactly covered by said second window assembly.

11. The apparatus of claim 10 wherein said hurricane and break-in resistant partition is metal.

12. The apparatus of claim 11 wherein said hurricane and break-in resistant partition is perforated stainless steel.

13. The apparatus of claim 11 wherein said hurricane and break-in resistant partition is a stainless steel screen with strands and wherein said strands of said screen are approximately 0.03 inches in diameter and wherein there are approximately one hundred and forty four strands per square inch of said screen.

14. The apparatus of claim 11 wherein said first window assembly is a single hung window assembly and said movable first window assembly partition moves vertically up and down.

15. The apparatus of claim 11 wherein said first window assembly is a sliding assembly and said movable first window assembly partition moves horizontally left and right.

16. In a structure with a first window assembly with a movable partition with an interior surface and an exterior surface, the partition movable from a closed position to an open position, a method for a hurricane and break-in resistant window comprising:
a. providing a second window assembly, which is approximately identical in dimension to said first window assembly with a first movable hurricane and break-in resistant partition, the first movable hurricane and break-in resistant partition conformed to move in the same manner as the movable first window assembly partition from a closed position to an open position; and
b. connecting said second window assembly over said first window assembly such that said first window assembly is exactly covered by said second window assembly.

17. The method of claim 16 wherein said hurricane and break-in resistant partition is perforated stainless steel.

18. The method of claim 16 wherein said hurricane and break-in resistant partition is stainless steel screen wherein strands of said screen are approximately 0.03 inches in diameter.

19. The method of claim 16 wherein said first window assembly is a single hung window assembly and said movable partition moves vertically up and down.

20. The method of claim 16 wherein said first window assembly is a sliding assembly and said movable partition moves horizontally left and right.
